(19) United States
(12) Patent Application Publication
(10) Pub. No.: US 2015/0256764 A1
(43) Pub. Date: Sep. 10, 2015

(54) ACTIVE-TRACKING BASED SYSTEMS AND METHODS FOR GENERATING MIRROR IMAGE

(71) Applicant: Guy M. Besson, Broomfield, CO (US)

(72) Inventor: Guy M. Besson, Broomfield, CO (US)

(21) Appl. No.: 14/639,322

(22) Filed: Mar. 5, 2015

Related U.S. Application Data
(60) Provisional application No. 61/948,471, filed on Mar. 5, 2014.
(60) Provisional application No. 61/997,471, filed on May 9, 2014.

(51) Int. Cl. H04N 5/262; H04N 13/02; H04N 7/18

(52) U.S. Cl. CPC H04N 5/2628; H04N 7/183; H04N 13/0278

(57) ABSTRACT

An active-tracking based system for generating a mirror image includes a position sensing module for determining the position of an observer relative to a surface, and a camera module for generating the mirror image based upon the position determined by the position sensing module, as the mirror image would have been experienced by the observer if the surface had been a mirror. An active-tracking based method for generating a mirror image includes (a) determining the position of an observer relative to a surface, (b) capturing at least one image, and (c) generating, from the at least one image, the mirror image as the mirror image would have been experienced by the observer if the surface had been a mirror.

### CROSS REFERENCE TO RELATED APPLICATIONS

This application claims benefit of priority to U.S. Provisional Patent Application Ser. No. 61/948,471, filed Mar. 5, 2014, and to U.S. Provisional Patent Application Ser. No. 61/997,471, filed May 9, 2014. Each of the above-identified patent applications is incorporated herein by reference in its entirety.

### BACKGROUND

Television displays, computer and cell-phone screens are widely available in modern society. Large area television screens and computer displays have become available at such a low price that they commonly figure in several rooms of a modern society typical family or personal residence.

When not in use to present a television program, computer output, or other moving scene recorded on a medium such as digital video disc (DVD), video tape, or solid-state memory, such screen typically presents a dark aspect. This dark or otherwise blend aspect is in vivid contrast to the life-like images that modern displays are capable of generating and presenting. The life-like characteristics include very high spatial resolution, high dynamic range, capability of representing fine contrast of colors and shades of gray, high frame rates, high temporal resolution, large color palette, and luminous brilliance. “Screen savers” that loop through a pre-selected or random sequence of images break the monotony.

Programmable computers and similar devices have also become widely available at low cost, and are omnipresent in modern society.

Optical cameras and associated digital sensors have followed the electronics technology evolution curves and have become widely available in small formats; such as optical cameras and electronic solid-state image sensors commonly available at low cost for vehicular applications, for example. Such devices may integrate an optical lens or combination of lenses with for exemplary illustration a charge-coupled device (CCD) or complementary-metal-oxide-semiconductors (CMOS) chip that allows image formation and digital recording in a compact format. CMOS imagers are compatible with mainstream silicon chip technology and, since transistors are made by this technology, on-chip processing is possible (see for example G. C. Hoist, “CCD Arrays, Cameras, and Displays”, Second edition, SPIE Optical Engineering Press, 1998). Optical sensor prices have decreased so significantly that they are now found ubiquitously in personal electronic devices such as cellular telephones.

Sensors, such as infrared sensors, ultrasonic sensors, radio-frequency sensors, have become widely available at low cost, and enable the detection of a moving object in the vicinity of the sensor(s). Such sensors are now in widespread use in automobiles, as warning systems indicative of the presence of an object, animal, or human being in the proximity to the car; as for example in use on rear vehicle bumpers to alert the driver and or automobile computer of the presence of an obstacle directly in or in the relative proximity of the moving vehicle. Other applications, such as perimeter security, have been known and practiced for years. Recently, interactive electronic systems, such as Microsoft Kinect, have been introduced that rely on the substantially instantaneous detection of a user's presence, location, and body motion and gestures.

Image processing, including processing of image sequences, has made significant advances since the time of the earliest analog recording devices. Most imaging nowadays is either recorded directly by a digital (pixelated) recording device, or a digital version is made available to the user after initial analog capture. Digital image processing includes techniques for noise reduction; contrast enhancement; coding and compression; rendition and display; and other techniques as known in the art.

Image merging is a term used herein to describe the process by which two input images are processed to generate a third image which contains information or features extracted from both input images. Examples known in the art include image fusion, wherein images of the same patient anatomy acquired by two different imaging modalities, such as computed tomography (CT) and magnetic resonance imaging (MRI), are combined to generate a merged image containing information from both associated CT and MRI input cross-section images. A method to merge or fuse two images of the same patient anatomy obtained by two different modalities is based on the mutual information measure. Another example from the medical imaging field is found in longitudinal studies, where the same anatomy of the same patient is imaged at time intervals; and new information is found (and displayed) by analyzing image changes from one acquisition to the other. This later technique is used in lung cancer screening and monitoring of lung nodules, for example. As yet another example, in aerial surveillance, pictures of a scene acquired at different wavelength (such as visible and infrared, respectively) are merged or fused to present one coherent scene where the relevant information is emphasized for the visual human observer, or for subsequent computer image analysis. Synthetic aperture radar is another common application where a final image is synthesized from a plurality of image data acquisition, as known in the art.

Image synthesis, whereby in one application a single image is generated from a multiplicity of input image sensors, is a field that has seen much recent development. Stitching, optical axis correction, merging, and other techniques as known in the art enable the generation of a single image from a plurality of sensors, the synthesized image appearing to the observer as if it had been acquired seamlessly by a single “wide-angle” camera—yet without the image distortions commonly associated with early “fish-eye” cameras. An example of an application is in vehicular technology, where a scene representing what the driver would see if he were to turn around and look back is synthesized from a multiplicity of sensors and shown on a display mounted on the vehicle dashboard.

Augmented reality is a live direct or indirect view of a physical, real-world environment whose elements are augmented (or supplemented by computer-generated sensory input such as sound, video, graphics, or GPS data). It is related to a more general concept called mediated reality, in which a view of reality is modified by a computer. As a result, the technology functions by enhancing one's current perception of reality. By contrast, virtual reality replaces the real world with a simulated one.

Virtual reality provides a computer-generated environment that aims at simulating physical presence in either a local environment or a simulated environment. Virtual reality includes remote communication and the providing of a virtual presence to the users of remote communication device, via tele-presence and tele-existence. The simulated environment may aim to emulate the real world to create a life-like experience, or may generate an artificial world for the purpose of entertainment or the communication of an environment likely to generate specific experiences in the user.

Telecommunication devices have evolved through improved bandwidth and end-user technologies such as sound, displays, three-dimensional displays that emulate an enhanced perception of depth of field, and integrated haptic devices and other sensory inputs. There exist a number of technologies that aim at achieving an improved experience of depth in an observer of a display. Exemplary applications of these technologies include figure stereoscopes, time-multiplexing displays, polarized presentation displays, specular displays for auto stereo scopy (parallax stereograms), integral photography, slice-stacking displays, holographic imaging and holographic stereograms. This field is rapidly evolving, and it is expected that improved means of visualizing three-dimensional scenes will soon be commercially available.

### SUMMARY

In an embodiment, an active-tracking based system for generating a mirror image includes a position sensing module for determining the position of an observer relative to a surface. The active-tracking based system further includes a camera module for generating the mirror image based upon the position determined by the position sensing module, as the mirror image would have been experienced by the observer if the surface had been a mirror.

In an embodiment, an active-tracking based method for generating a mirror image includes determining the position of an observer relative to a surface. The active-tracking based method further includes capturing at least one image and generating, from the at least one image, the mirror image as the mirror image would have been experienced by the observer if the surface had been a mirror.

In one embodiment, a method of generating an image for presentation on an addressable display is provided. The method includes sensing the relative orientation of an observer with respect to the display, and generating an image from one or more optical sensor(s) to mimic the operation of a mirror. The method generates a synthetic image in response to input optical camera(s) and relative observer positions and orientations. The synthetic image is presented on the addressable display. From the point of view of the observer, the synthetic image is representative of a scene that would be presented were the addressable display be replaced by a passive optical mirror; or a synthetic image representative of a scene that would be presented to the observer by a passive optical mirror of known shape and of known location with respect to the active display.

Alternatively or in addition, the synthesized image may be processed by computer means in any of a variety of ways to present to the observer an enhanced image as compared to that a passive mirror would provide. For example, the displayed image may have been digitally processed to enhance resolution; to increase luminosity of selected features; or to automatically segment and present specific image features.

In another embodiment, a display system comprising an addressable luminous display, a computer, at least one position sensor, and at least one optical camera or sensor is provided. The system determines the relative orientation of an observer with respect to the display surface and generates an image from the collection of input optical camera(s), such that an image a presented to the observer that is similar to the image that would be created were the display surface be a mirror. The generated image is synthesized by a computer from input optical cameras and input observer relative position with respect to display surface. This is achievable either by controlling and orienting one or a plurality of optical sensor as a function of the observer's position with respect to the display; or by acquiring one or a plurality of images from one or a plurality of fixed or controllable image sensors, and synthesizing one image for display from the plurality of acquired images as a function of the estimated observer's position and the known positions of the various optical sensors.

In another embodiment, a display system comprising an addressable luminous display, a computer, at least one position sensor, and at least one optical device or camera is provided. The system determines the relative orientation of an observer with respect to the display surface and generates an image from the collection of input optical camera(s), such that an image a presented to the observer that is similar to the image that would be created and presented to the observer by a passive optical mirror of known shape and of known location and position with respect to the active display (and therefore, with respect to the observer). The generated image is synthesized by a computer from input optical cameras and determined observer relative position with respect to display surface.

Further, an active tracking and mirror display such as disclosed in the present invention, enables the combination of various image streams; such that the “active mirror” image synthesized by the system in response to the detection, characterization, and location determination of an observer, may be combined with other image streams: such as for example image sequences obtained from a data base; or in another example, an image sequence remotely acquired and transmitted substantially in real time to the active tracking and mirror display system. In such a way, a “virtual reality” image sequence is presented to the observer that accounts for the observer position with respect to the display, and merges or synthesizes an associated “mirror image” with an image stream either previously recorded or recorded somewhere else and transmitted substantially in real-time to the active display system. In such an embodiment, feature(s) from one input image stream (say, for illustration, the pre-recorded or remotely acquired image stream) are extracted and merged with the input image stream generated by the active tracking part of the system; in such a way that a virtual-reality type image sequence is generated for presentation to the system observer/viewer. As an illustration, the face and or body of a person may be extracted from the pre-recorded or remotely acquired image sequence/stream, and merged into the active mirror generated image sequence/stream; so that the system observer/viewer sees that person's face and or body as if it were in reality seen through a mirror: the remote person appears immersed into the local observer environment, merged within the image field provided by the active tracking and mirror display itself. Thus the system and methods of the present invention provide a virtual reality representation of a remote video conference/meeting participant.

In yet another embodiment, a computer readable medium is provided. The medium is encoded with a program configured to instruct a computer to generate a synthetic image from at least one optical camera and from an input direction representative of the relative position of an observer with respect to the display surface. In one embodiment, the computer also records the synthetic image or image sequence generated by the active tracking and mirror display. In another embodiment, the computer also records a synthetic image or image sequence generated by merging the active tracking and mirror image generated by the system with another image either previously recorded or remotely acquired. The recording thus enables later virtual-reality rendition by merging the recorded video stream with a second video stream; the second video stream being either synthesized by the system as described above, obtained from a second recording, or remotely acquired and transmitted to the system.

In another embodiment, the present invention relates to the field of telecommunications. Two or more remote users each utilizing a system per the present invention could communicate in essentially real-time with an enhanced remote presence being achieved by the method and devices described below. Each user benefiting from a virtual reality representation of the remote user in his/her local environment.

Additionally, the present invention also relates to the generation and display of three-dimensional information, as a means to further improve upon the quality of the life-like experiences made possible through the devices and methods outlined herein.

### BRIEF DESCRIPTION OF THE DRAWINGS

FIG. 1 illustrates an active-tracking based system for generating, and optionally displaying, a mirror image representing a scene that appears, to an observer, to be that reflected by a passive optical mirror, according to an embodiment.

FIG. 2 illustrates an active-tracking based method for generating, and optionally displaying, a mirror image representing a scene that appears, to an observer, to be that reflected by a passive optical mirror, according to an embodiment.

FIG. 3 illustrates a “honeycomb” camera module having a plurality of camera devices arranged on a curved surface and oriented along different directions, according to an embodiment,

FIG. 4 illustrates an active-tracking based system for generating, and optionally displaying, a mirror image, wherein the active-tracking based system includes a rotatable camera module, according to an embodiment.

FIG. 5 illustrates an active-tracking based system for generating, and optionally displaying, a mirror image, wherein the active-tracking based system includes a rotatable position sensor and a plurality of camera devices, according to an embodiment.

FIG. 6 illustrates an active-tracking based system for generating, and optionally displaying, a mirror image, wherein the active-tracking based system includes a rotatable camera module and a rotatable position sensor, according to an embodiment.

FIG. 7 illustrates another active-tracking based system for generating, and optionally displaying, a mirror image, according to an embodiment.

FIG. 8 illustrates yet another active-tracking based system for generating, and optionally displaying, a mirror image, according to an embodiment.

FIG. 9 illustrates an active-tracking based method for generating, and optionally displaying, a mirror image, using at least one rotatable camera device, according to an embodiment.

FIG. 10 illustrates an active-tracking based method for generating, and optionally displaying, a mirror image, using a plurality of camera devices, according to an embodiment.

FIG. 11 illustrates an active-tracking based system for generating, and optionally displaying, a mirror image, and which includes merge and record functions, according to an embodiment.

FIG. 12 illustrates another active-tracking based system for generating, and optionally displaying, a mirror image, and which includes merge and record functions, according to an embodiment.

FIG. 13 illustrates yet another active-tracking based system for generating, and optionally displaying, a mirror image, and which includes merge and record functions, according to an embodiment.

FIG. 14 illustrates a method for merging two input images, according to an embodiment.

FIG. 15 illustrates a live-video conference system that includes two communicatively coupled active-tracking based systems for displaying a mirror image, wherein each active-tracking based system has merge and record functions, according to an embodiment.

FIG. 16 illustrates an active-tracking based method for generating live video conference imagery, according to an embodiment.

FIG. 17 illustrates generation of a three-dimensional model of an observer by an active-tracking based system of the live video conference system of FIG. 15, according to an embodiment.

### DETAILED DESCRIPTION OF THE EMBODIMENTS

Disclosed herein are active-tracking based systems and methods that generate, and optionally display, a mirror image or mirror image sequence representing a scene that appears, to an observer, to be that reflected by a passive optical mirror. The active-tracking based systems and methods determine the position of the observer to generate the mirror image or mirror image sequence, and may produce life-like imagery for a display, such as a large area television screens and computer displays.

An optical mirror is a familiar object throughout human society in any place in the world. Optical mirrors have been known since antiquity. Herein, the terms “optical mirror” and “mirror” are used interchangeably. An optical mirror brings light in a room, allows self-observation, and brings a sense of depth to many small rooms. The presently disclosed active-tracking based systems and methods provide a mode of operation of an active, addressable display, such that the display presents to the observer a scene similar to that provided by an optical mirror, whether the mirror is flat or not. Such a display mode allows yet another use for the display, in essence that of an optical mirror (or “passive display”).

In one example, the active-tracking based systems and methods disclosed herein produce an image that presents, to an observer, the mirror image that the observer would have experienced if the display had been a passive optical mirror. In another example, these active-tracking based systems and methods produce an image that presents, to an observer, the mirror image that the observer would have experienced if the display had been replaced by a passive optical mirror of known shape and location with respect to the display.

Also disclosed herein are active-tracking based systems and methods that generate a mirror image, or mirror image sequence, representing a scene that appears, to an observer, to be that reflected by a passive optical mirror, and merge such a mirror image with a second image or image sequence. In one implementation, such active-tracking based systems and methods are used to generate an augmented reality or virtual reality experience, whereby an image or rendition of a scene is generated or synthesized from a multiplicity of image and other inputs, to create in an observer the illusion or semblance that the displayed scene is real. In another implementation, two such active-tracking based systems are used to perform improved remote video communication between two users to generate an augmented reality or virtual reality experience, whereby an image or rendition of a scene is generated or synthesized from a multiplicity of image and other inputs, to create in an observer the illusion or semblance that the displayed scene is real.

In certain embodiments, the active-tracking based systems and methods discussed above generate, and optionally display, three-dimensional images. Such embodiments may generate and render a three-dimensional model of an observer or, in the case of remote video communication, two observers.

Herein, the terms “display”, “active display”, “visual display device,” “addressable display,” refer to any type of device such as CRT (cathode ray tube) monitor, LCD (liquid crystal display) screens, OLED (organic light emitting diodes) displays, plasma screens, projected image, indium gallium zinc oxide (IGZO) high-density displays, etc., used to visualize image information, such as image data represented in a computer as a grid or vector or array of luminous intensity values, and which is controlled by a computer as opposed to a “passive display” such as a light-reflecting surface, picture, or mirror.

Herein, the term “observer” refers to one of a human observer, an animal, a moving object, and more generally the trajectory of a moving (or stationary) point in space; such point being either traceable in space through some specific property (such as an electromagnetic emitter; light reflective property; etc.), or its trajectory (or location) pre-defined.

Herein, the terms “optical sensor,” “optical camera,” “camera”, “camera device” are used interchangeably and are not meant to be limited to the part of the electromagnetic spectrum that is directly visible by a human observer. Thus, a camera may be sensitive in the infrared region of the spectrum, for example. A camera may integrate an optical lens or combination of lenses with, for example, a charge-coupled device (CCD) or complementary-metal-oxide-semiconductor (CMOS) chip. Such a camera may allow image formation and digital recording in a compact format.

Herein, a “controller” is not limited to just those integrated circuits referred to in the art as a controller, but broadly refers to a computer, a processor, a microcontroller, a microcomputer, a programmable logic controller, an application specific integrated circuit, and/or any other programmable circuit. Examples of mass storage device include a nonvolatile memory, such as a read-only memory (ROM), and a volatile memory, such as a random access memory (RAM). Other examples of mass storage device include a floppy disk, a compact disc-ROM (CD-ROM), a magneto-optical disk (MOD), an optical memory, a digital versatile disc (DVD), a solid-state drive memory.

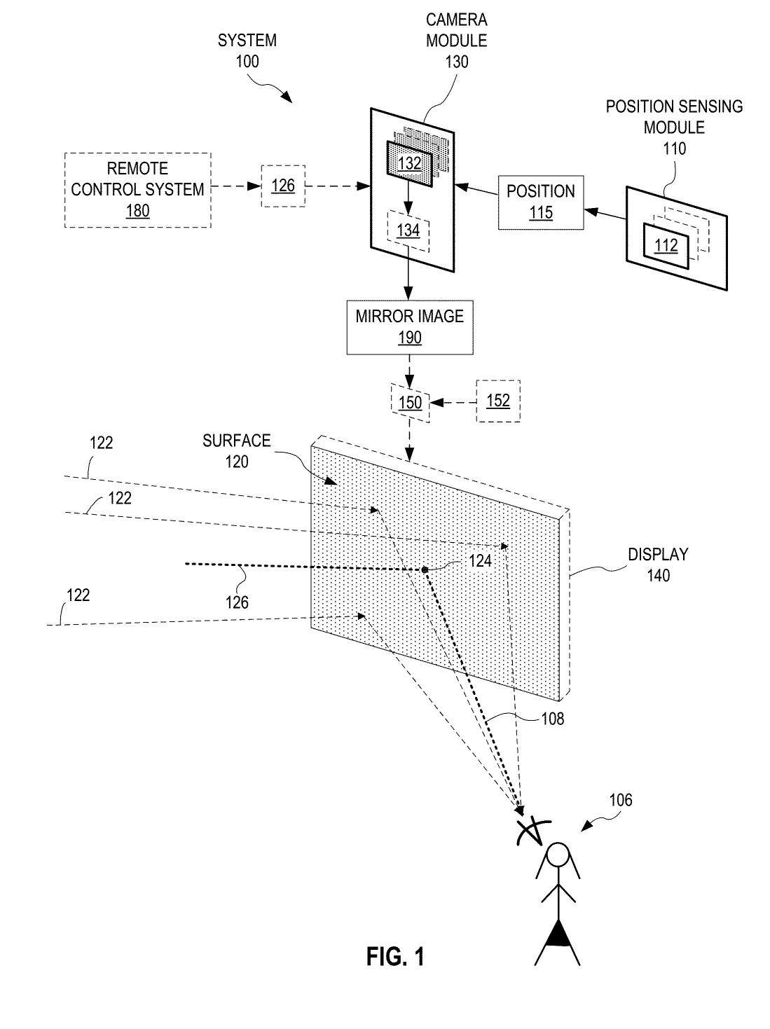

FIG. 1 illustrates one exemplary active-tracking based system 100 for generating, and optionally displaying, a mirror image 190 representing a scene that appears, to an observer 106, to be that reflected by a passive optical mirror located at a surface 120.

Surface 120 may be a physical surface, such as the surface of an addressable luminous display 140, or a virtual surface. Although shown in FIG. 1 as coinciding with display 140, surface 120 may be, at least in part, different from the surface of display 140, without departing from the scope hereof. Additionally, surface 120 may have shape differently from that shown in FIG. 1 and/or be curved. Additionally, surface 120 may include two or more separate surfaces, each of known position and orientation. Surface 120 may represent all of the surface of display 140, a sub-portion of the surface of display 140, or several sub-portions of the surface of display 140. Display 140 is not necessarily considered flat, or rectangular. Display 140 may be comprised of several surfaces, each of known position and orientation.

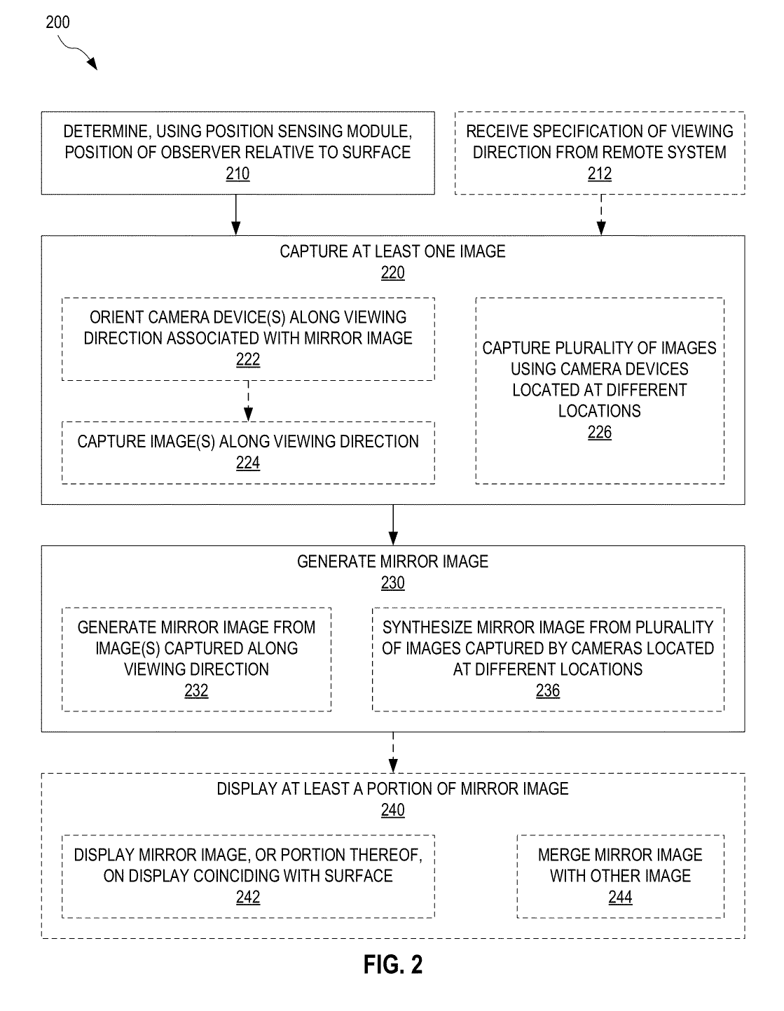

FIG. 2 illustrates one exemplary active-tracking based method 200 for generating, and optionally displaying, mirror image 190 (FIG. 1). FIGS. 1 and 2 are best viewed together.

Active-tracking based system 100 includes a position sensing module 110 and a camera module 130. Position sensing module 110 determines the position 115 of observer 106 relative to surface 120. Position sensing module 110 includes one or more position sensors 112 that cooperate to sense observer 106 and determine the position of observer 106 relative to surface 120. Camera module 130 includes at least one camera device 132 configured to capture an image. Each camera device 132 may include an optical lens and a digital image sensor. Camera module 130 may further include an image generator 134 that processes one or more images captured by camera device(s) 132 to generate an output image. Camera module 130 is communicatively coupled with position sensing module 110. Optionally, active-tracking based system 100 further includes one or both of display 140 and an image processing module 150.

In a step 210 of method 200, position sensing module 110 determines position 115 of observer 106 relative to surface 120. In one example, position sensing module 110 determines a position vector 108 that indicates position 115 with respect to a coordinate system of surface 120 having origin 124. Origin 124 is the center of surface 120, for example. Position vector 108 may indicate (a) the direction in which observer 106 is located relative to surface 120, and the distance between surface 120 and observer 106, or (b) only the direction in which observer 106 is located relative to surface 120. Position vector 108 may represent an estimate of the location of observer 106.

Position sensor(s) 112 may use visible light, infrared light, or other electromagnetic radiation to determine the presence of an observer 106. Detected electromagnetic radiation maybe either reflected by surfaces of observer 106 (such as clothing or skin), or emitted by observer 106, as known from Planck's law of black-body radiation. Alternatively or in combination, position sensor(s) 112 may use sound or ultrasound information to determine the position of observer 106. In one exemplary scenario, observer 106 is a human observer. Position sensor(s) 112 may determine position 115 through various sensing methods as known in the art, such as used in remote sensing applications (radar or sonar, for example). Position sensor(s) 112 may also use other technology, such as ultrasound sensing or pressure sensing, or a combination thereof. In one embodiment, position sensor(s) 112 reacts in response to an element worn by observer 106, such as an electromagnetic emitter, or electromagnetic reflector. In another embodiment, position sensor(s) 112 does not require the observer to wear any device specific element. It is noted that position sensor(s) 112 may include optical camera(s) and computer means to automatically extract image features, such as an observer's face and eyes, to determine said observer location in relation to surface 120. Such computations may include automated image analysis techniques such as image segmentation, pattern recognition, feature extraction and classification, and the like, as is known in the art. Position sensor 112 may be a motion detector.

In one example, a single position sensor 112, or each of a plurality of position sensors 112, generate sufficient data that position sensing module 110 may determine the position of observer 106 therefrom. In another example, each of a plurality of position sensors 112 provide incomplete position information for observer 106, which is cooperatively processed by position sensing module 110 to determine the position of observer 106.

There may be more than one observer 106, in which case position sensing module 110 may (a) generate mirror image 190 based upon position vector 108 to the closest observer 106, (b) generate mirror image 190 based upon an average or weighted average of position vectors 108 associated with the multiple observers 106, or (c) generate mirror image 190 based upon user input specifying a single observer 106 for which mirror image 190 should be generated. In the present disclosure, it is understood that observer 106 may refer to a plurality of observers 106 and that active-tracking based systems and methods disclosed herein may be configured to handle multiple observers 106 as discussed above, for example.

In a step 220 of method 200, camera module 130 uses camera device(s) 132 to capture at least one image. In a step 230 of method 200, camera module 130 generates mirror image 190 based upon the image or images captured in step 220. Camera module 130 may output, as mirror image 190, an image captured in step 220, or camera module 130 may utilize image generator 134 to process one or more images captured in step 220 to generate mirror image 190 therefrom.

In one embodiment, camera module 130 includes a single camera device 132 and mirror image 190 corresponds to the image captured by this single camera device.

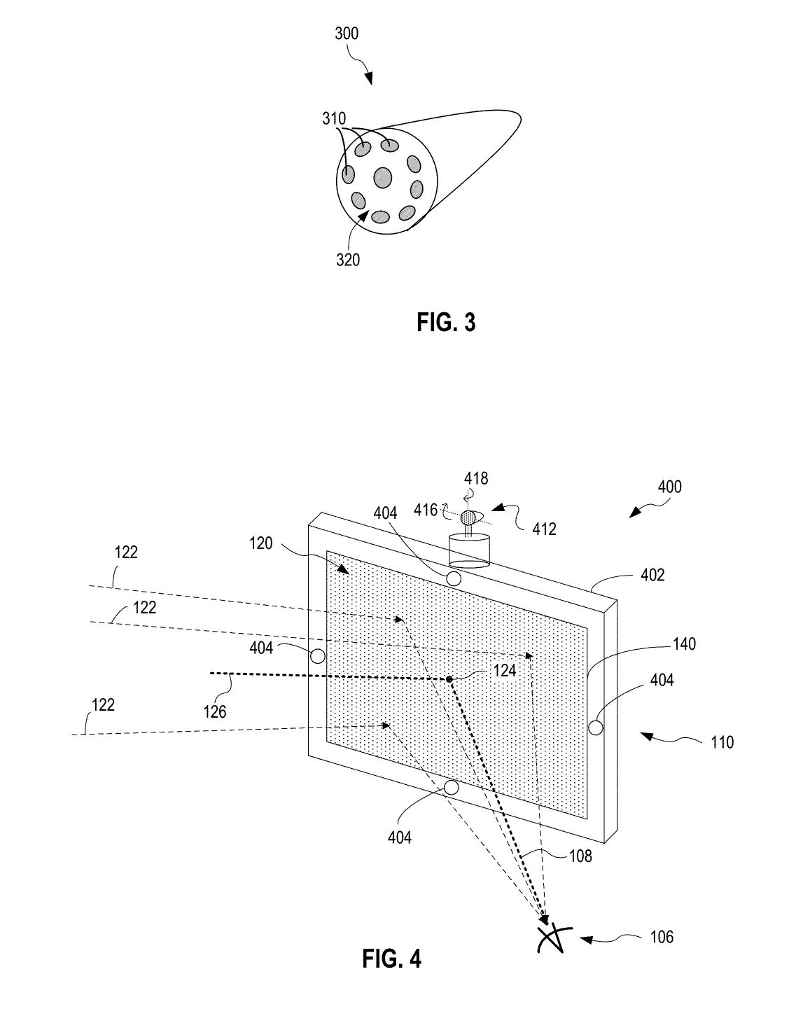

In another embodiment, camera module 130 includes a plurality of camera devices 132, each oriented at a different angle, for example as shown in FIG. 3, discussed below.).

In yet another embodiment, camera module 130 includes one or more light-field optical cameras (also known as a plenoptic camera), each implementing a camera device 132. A light-field optical camera uses a micro-lens array to collect “four-dimensional” light field information about a scene, which enables the generation of several images from a single captured image. Such acquisition technology is helpful in a number of computer vision applications, and allows the acquisition of images that may be refocused after they are taken, as well as permitting a slight change in view angle after acquisition.

In one embodiment, step 220 implements sequential steps 222 and 224, and step 230 implements a step 232. This embodiment of method 200 utilizes an embodiment of camera module 130, which includes at least one camera device 132 that has flexible orientation.

In step 222, camera module 130 receives position 115. Based upon position 115, camera module 130 orients at least one camera device 132 along a viewing direction 126 associated with mirror image 190 on surface 120. For example, camera module 130 orients at least one camera device 132 such that the optical axis of each camera device 132 is parallel to viewing direction 126. Viewing direction 126 is the reflection, off surface 120 or an extension thereof, of the direction of observer 106's view of surface 120. It is noted that surface 120 is a distributed surface, and the actual viewing direction may vary across surface 120. At origin 124, the viewing direction is the reflection of position vector 108 off surface 120. Viewing direction 126 may refer to a direction that is generally consistent with viewing directions across surface 120, given position 115 of observer 106. Viewing direction 126 may be the average viewing direction across surface 120. Alternatively, viewing direction 126 may depend on the location of camera device 132 and be a reflection of the vector from observer 106 to camera device 132 off a plane that is defined by surface 120, or an extension thereof, at the location of camera device 132. In one example of step 222, camera module 130 orients a single camera device 132 along viewing direction 126. In another example of step 222, camera module 130 orients a plurality of camera devices 132 along a plurality of viewing directions that may be identical or slightly differ based upon the location of respective camera devices 132. In step 224, each camera device 132 used in step 222 captures an image along the associated viewing direction.

In step 232, camera module 130 generates mirror image 190 from the image or images captured in step 224 along viewing direction 126. In one example of step 232, camera module 130 outputs an image, captured in step 224, as mirror image 190. In another example of step 232, image generator 134 processes a plurality of images captured in step 224 to generate mirror image 190 therefrom. Image generator 134 may utilize such a plurality of images to (a) synthesize mirror image 190 to produce a mirror image representative of that generated by a distributed surface, such as a passive mirror surface, (b) achieve a wider field of view than that provided by any individual camera device 132, and/or (c) generate a three-dimensional mirror image 190.

In another embodiment, step 220 implements a step 226 and step 230 implements a step 236. This embodiment of method 200, utilizes an embodiment of camera module 130, which includes a plurality of camera devices 132 that have fixed orientation and are located at a plurality of different locations. In step 226, the plurality of camera devices 132 captures a plurality of images. In step 236, image generator 134 receives position 115. Based upon position 115, image generator 134 processes the plurality of images, captured in step 224, to synthesize an image along viewing direction 126, thus generating mirror image 190. This embodiment of method 200 may utilize the plurality of camera devices 132 to (a) synthesize mirror image 190 to produce a mirror image representative of that generated by a distributed surface, such as a passive mirror surface, (b) achieve a wider field of view than that provided by any individual camera device 132, and/or (c) generate a three-dimensional mirror image 190. Methods to synthesize a scene from a plurality of image sequences include image fusion; image segmentation; image stitching; image generation; and related techniques as known in the art of image processing. Step 236 may utilize one or more of such methods.

In one embodiment, synthesizing mirror image 190 includes analyzing a video stream of images from a camera focused on the user, and determining the observer 106's direction of gaze as an input in computing mirror image 190 that most accurately represents what the observer would see if display 140 were replaced by a passive mirror.

In one embodiment, mirror image 190 may essentially correspond to an image that would be generated at observer 106's location by a reflector or partial reflector of known surface shape, known orientation and position with respect to observer 106, and optionally of known light reflecting, refracting, attenuating, and transmitting properties, wherein such refracting, attenuating, transmitting properties may be position-dependent on the reflective or partially reflective surface. It is noted that neither position sensing module 110 nor camera module 130 need to be physically integrated with display 140 (if included). However, method 200 utilizes, in real time, the position and orientation of position sensor(s) 112 and camera device(s) 132 with respect to surface 120.

Optionally, method 200 may further include a step 240 of displaying at least a portion of mirror image 190 on display 140. In one embodiment, surface 120 coincides with display 140 (as shown in FIG. 1), and step 240 implements a step 242 of displaying at least a portion of mirror image 190 on an associated portion of display 140.

Display 140 is, for example, a cathode-ray-tube (CRT), flat-panel display using liquid-crystal-display (LCD), plasma flat-panel display, light-emitting-diode (LED) displays, organic light-emitting diodes displays, projector displays, or generally any addressable display capable of presenting an image (scene) either digitally acquired or digitally sampled from an analog input.

Step 240 may include a step 244, wherein (a) image processing module 150 merges mirror image 190 with another image 152 to produce a merged image, and (b) display 140 displays this merged image. Without departing from the scope hereof, method 200 may generate the merged image without displaying it.

In certain embodiments, camera module 130 is communicatively coupled with a remote control system 180 that specifies viewing direction 126. In such embodiments, active-tracking based method 200 includes a step 212 of receiving a specification of viewing direction 126 from remote control system 180. This corresponds to a scenario wherein observer 106 is a point in space having a predefined location or trajectory. In one example, remote control system 180 communicates a viewing direction 126 corresponding to a view of interest. In another example, remote control system 180 communicates a series of viewing directions 126 to perform a raster scan. This raster scan may serve to search, and optionally locate, an object of interest such as a human observer 106. After locating this object of interest, using the raster scan, method 200 may proceed to perform step 210 to actively track this object of interest. Step 212 may replace step 210, without departing from the scope hereof. Likewise, remote control system 180 may replace position sensing module 110.

Neither active-tracking based system 100 nor active-tracking based method 200 require that observer 106 is included in mirror image 190. Observer 106 may be located at any position 115 relative to surface 120, as long as the associated viewing direction 126 is viewable by at least one camera device 132.

Although not explicitly shown in FIG. 1, active-tracking based system 100 may include one or more computer systems to perform at least a portion of the functionality of position sensing module 110, camera module 130, image processing module 150, and/or display 140, without departing from the scope hereof. This computer may be, or include, a microprocessor, microcomputer, a minicomputer, an optical computer, a board computer, a field-programmable gate array (FPGA), a complex instruction set computer, an ASIC (application specific integrated circuit), a reduced instruction set computer, an analog computer, a digital computer, a molecular computer, a quantum computer, a cellular computer, a superconducting computer, a supercomputer, a solid-state computer, a single-board computer, a buffered computer, a computer network, a desktop computer, a laptop computer, a scientific computer or a hybrid of any of the foregoing; or a known equivalent. At least a portion of method 200 may be implemented as machine-readable instructions encoded on non-transitory media within such a computer, and executed by a processor within this computer.

Although not shown in FIG. 2, method 200 may repeat steps 210, 220, 230, and optionally 240 to generate a stream of mirror images 190 or a stream of images each including at least a portion of a corresponding mirror image 190. Thereby, method 200 may dynamically update display 140 in accordance with a possibly varying location of observer 106.

FIG. 3 illustrates one exemplary “honeycomb” camera module 300 having a plurality of camera devices 310 arranged on a curved surface 320 and oriented along different directions. Camera module 300 is an embodiment of camera module 130 (FIG. 1), and camera device 310 is an embodiment of camera device 132. The optical axes of camera devices 310 diverge or converge away from curved surface 320 toward the scene viewed by camera devices 310. Curved surface 320 may be a paraboloid. By virtue of the honeycomb arrangement, camera module 300 enables correction for parallax effects. Parallax effects occur since a passive mirror processes incoming light on a distributed surface, whereas a single camera has a unique defined optical axis. Therefore, providing a multiplicity of cameras with optical axis pointing at a multiplicity of angles enables the synthesizing of an image field representative of that generated by a passive mirror surface.

In certain embodiments, active-tracking based system 100 implements honeycomb camera module 300 as camera module 130. In one such embodiment, a plurality of camera devices 310 captures a respective plurality of images in step 226 of method 200 (FIG. 2). In step 236, image generator 134 synthesizes this plurality of images to generate mirror image 190.

FIG. 4 illustrates one exemplary active-tracking based system 400 for generating, and optionally displaying, mirror image 190 (FIG. 1). Active-tracking based system 400 is an embodiment of active-tracking based system 100 and may implement active-tracking based method 200 (FIG. 2).

Active-tracking based system 400 includes a display device 402 with (a) display 140 and (b) position sensing module 110. In active-tracking based system 400, position sensing module 110 includes one or a plurality of position sensors 404. Each position sensor 404 is an embodiment of position sensor 112. Each position sensor 404 may be stationary. Active-tracking based system 400 further includes a rotatable camera module 412 which is an embodiment of camera module 130. Camera module 412 generates mirror image 190, and display 140 displays mirror image 190.

Through position determination computations performed by position sensing module 110, active-tracking based system 400 determines the position of observer 106 with respect to the coordinate system (including origin 124) of display device 402, as represented schematically by position vector 108 (assumed to originate at the coordinate system center).

Camera module 412 is rotatable about axes 416 and 418. In one example, axes 416 and 418 are essentially perpendicular, and combination of these two axes' rotations allows pointing camera module 412 in a range of directions with respect to display 140. For example, camera module 412 may be rotated about axes 416 and 418 to view any direction in optical communication with the side of surface 120 facing observer 106. Based upon position vector 108, active-tracking based system 400 orients camera module 412 and processes light collected by one or plurality of camera devices 132 within camera module 412 to generate or synthesize mirror image 190. Camera module 412 may be automatically and adaptively oriented to observe an optical scene as a function of a position vector 108, such that the optical scene captured by camera module 412 essentially corresponds to what observer 106 would see were display 140 replaced by an optical mirror. For example, camera module 412 is oriented to be generally aligned with viewing direction 126.

Camera module 412 may include one or more camera devices 132. For example, camera module 412 may be implemented as honeycomb camera module 300 (FIG. 3). In one embodiment, camera module 412 includes one or more light-field optical cameras.

In certain embodiments, camera module 312 includes a single rotatable camera device 132, and display device 402 includes a plurality of position sensors 404.

Although shown in FIG. 4 as being mechanically coupled with display 140, position sensor(s) 404 and/or camera module 412 may be located in known locations away from display device 402, without departing from the scope hereof. In this case, system 400 may include and utilize results of a calibration procedure to determine respective positions and orientation of camera module with respect to the coordinate system of display 140. Although not shown in FIG. 4, active-tracking based system 400 may include a computer for performing at least a portion of the functionality discussed above, as discussed in reference to FIG. 1. Without departing from the scope hereof, active-tracking based system 400 may be implemented without display 140. In this case, active-tracking based system 400 generates mirror image 190 and may communicate mirror image 190 to a display separate from active-tracking based system 400.

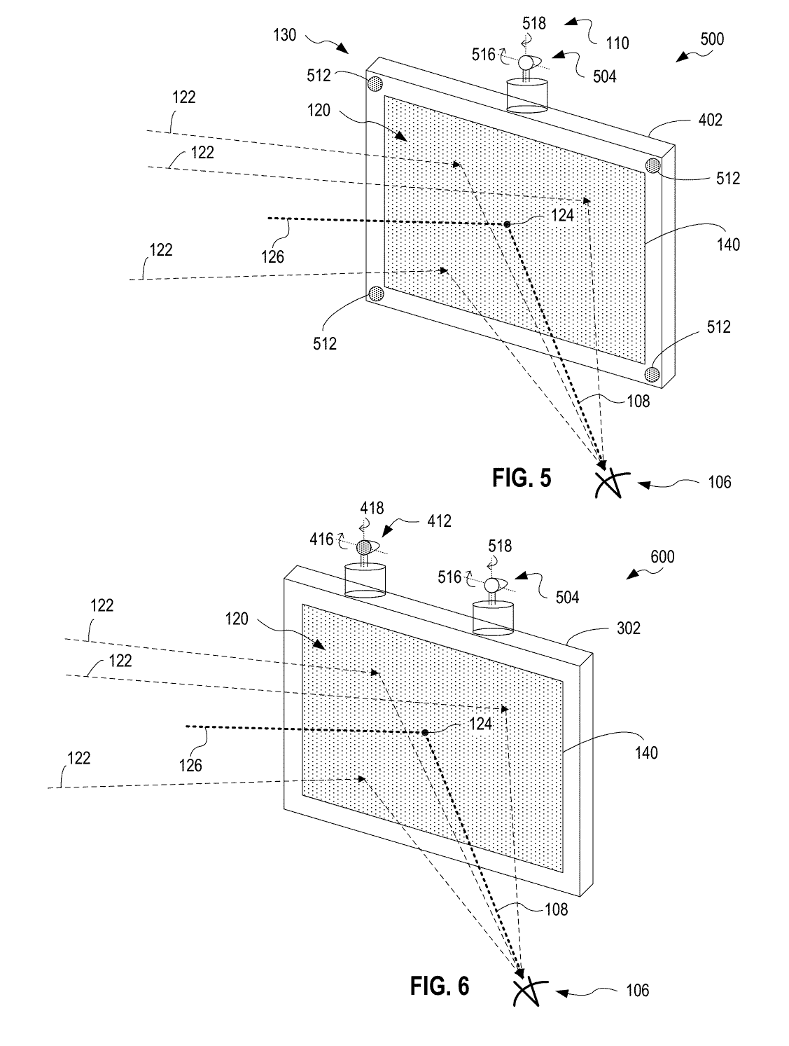

FIG. 5 illustrates one exemplary active-tracking based system 500 for generating, and optionally displaying, mirror image 190 (FIG. 1). Active-tracking based system 500 is an embodiment of active-tracking based system 100 and may implement active-tracking based method 200 (FIG. 2). Active-tracking based system 500 is similar to active-tracking based system 400 (FIG. 4), except that active-tracking based system 500 implements (a) position sensing module 110 as rotatable position sensing module 504 having a single position sensor, and (b) camera module 130 with a plurality of camera devices 512. Position sensing module 504 is an embodiment of position sensing module 110. Each camera device 512 is an embodiment of camera device 132.

Position sensing module 504 is rotatable about axes 516 and 518. In one embodiment, axes 516 and 518 are essentially perpendicular, and combination of these two axes' rotations allows pointing position sensing module 504 in a range of directions with respect to display device 302. In one example, position sensing module 504 is rotatable to detect an observer 106 regardless of the direction in which observer 106 is located relative to display 140. In another example, position sensing module 504 is rotatable to detect an observer 106 having a line-of-sight to display 140.

Position sensing module 504 may be automatically and adaptively oriented to track observer 106, and provide necessary data for calculation of position vector 108.

Each of the multiplicity of camera device(s) 512 may be either fixed or individually controllable and oriented in three-dimensional space with respect to display device 402. The multiplicity of optical inputs thus allows the generation of a synthesized mirror image 190, in step 236, that accurately simulates the output image that would be generated and seen by the observer were display 140 replaced by a passive optical mirror distributed over a surface of known position and orientation (or a plurality of such surfaces).

Synthesizing one view from a plurality of input views, provided by the plurality of camera devices 512, may be achieved with well-established camera technologies. Yet, new developments in the field of plenoptic photography make refocusing and slightly adjusting the main view angle of a given image possible after recording. It is clear that such technological advances could be leveraged in the present invention, by allowing each of a plurality of plenoptic (or “light field”) cameras to be refocused after data acquisition generally per the direction and depth of field desirable given a specific observer position vector, camera position with respect to display 140, and determined depth of field of the image to be synthesized. It may still be desirable to enable orientation control for each of these plenoptic cameras, so that only a minor correction for view direction need to be performed after image acquisition by each camera. The use of a plurality of spatially distributed optical cameras, and/or light-field cameras, enables the correction for various known optical effects such as parallax, and enables the generation of an image simulating accurately that that would be generated for a given observer of known location by a passive mirror of know shape and spatial extension. In one embodiment, this passive mirror that is being simulated is essentially of a location and spatial extend corresponding to display 140; in another, more general embodiment, the passive mirror that is being simulated for observer 106 may be of a different (but known) shape and location with respect to display 140.

FIG. 6 illustrates one exemplary active-tracking based system 600 for generating, and optionally displaying, mirror image 190 (FIG. 1) and may implement active-tracking based method 200 (FIG. 2). Active-tracking based system 600 is an embodiment of active-tracking based system 100. Active-tracking based system 600 is similar to active-tracking based system 400 (FIG. 4), except that active-tracking based system 600 implements (a) position sensing module 110 as position sensing module 504 (FIG. 5), and (b) camera module 130 as camera module 412 (FIG. 4).

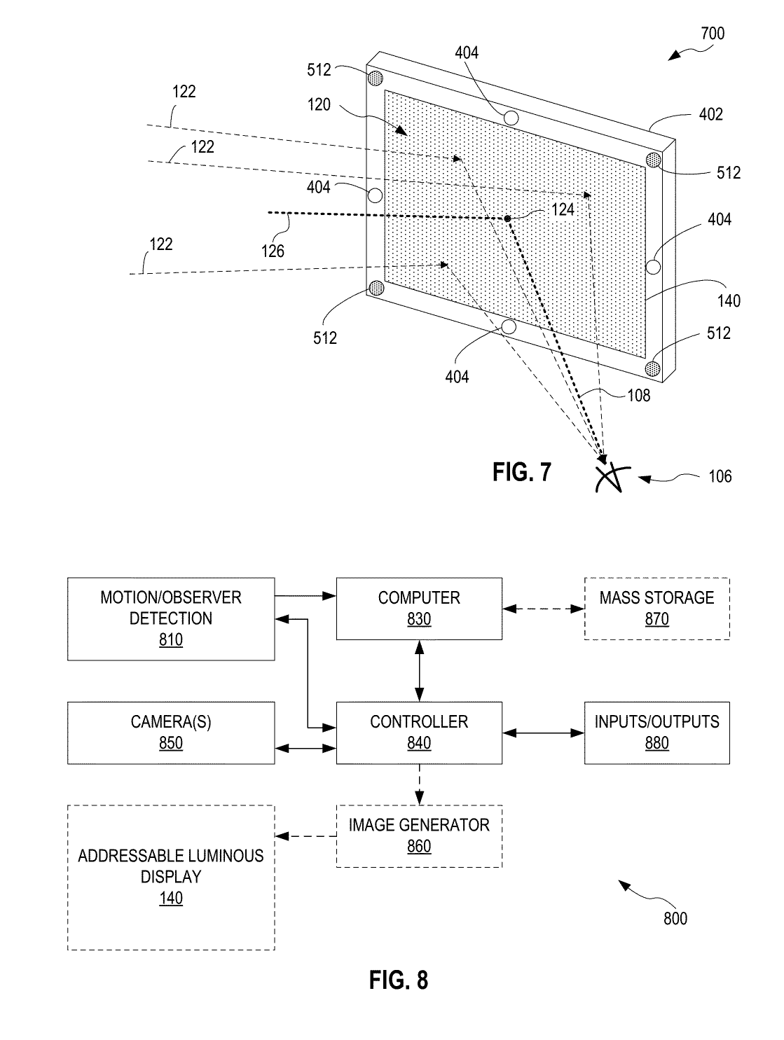

FIG. 7 illustrates one exemplary active-tracking based system 700 for generating, and optionally displaying, mirror image 190 (FIG. 1) and may implement active-tracking based method 200 (FIG. 2). Active-tracking based system 700 is an embodiment of active-tracking based system 100. Active-tracking based system 700 is similar to active-tracking based system 400 (FIG. 4), except that active-tracking based system 700 implements camera module 130 with camera devices 512 (FIG. 5) instead of implementing camera module 412.

FIG. 8 illustrates one exemplary active-tracking based system 800 for generating, and optionally displaying, mirror image 190 (FIG. 1). Active-tracking based system 800 is an embodiment of active-tracking based system 100.

Active-tracking based system 800 includes addressable luminous display 140 and a motion and observer detection sub-system 810, both of which may be operatively coupled to a computer 830 and/or to a controller 840. Motion/observer detection sub-system 810 includes at least one motion detection device (such as position sensor(s) 112) that employs electromagnetic radiation, sonic or ultrasonic technology, thermal imaging technology, or any means of detecting and tracking the presence of a human being or observer. For example, such motion detection device(s) may employ an optical camera together with image processing algorithms implemented on computer 830 which automatically detect and recognize the presence of an observer such as in one example a human being and extract observer features, such as the eyes and/or other facial features; from which a position vector 108 maybe estimated. Motion/observer detection sub-system 810 and associated computer program, executed by computer 830, extract features from identified moving object to define position vector 108. Computer 830 processes data from motion/observer detection sub-system 810 and generates a position vector estimate 108, which is input to controller 840.

In one embodiment, controller 840 controls direction-adjustable optical device(s) and/or camera(s) 412 (FIG. 4) and orients it to a direction such that the scene being imaged by optical device(s) 412 is substantially the scene that would be seen by observer 106 were display 140 replaced by an optical mirror.

In another embodiment, controller 840 determines, based upon position vector 108, viewing direction 126, and synthesizes, based upon viewing direction 126, mirror image 190 from a collection of optical input images from one or a plurality of fixed or adjustable camera devices 512 (FIG. 5). In one example, the plurality of camera devices 512 are substantially fixed with respect to the active-tracking based system. In another example, each or a subset of the camera devices 512 may be independently oriented as a function of the position vector 108 and of the sensor's known position on the active-tracking based system. The generation of mirror image 190 is carried out by computer 830 or optional image generator 860 using image processing techniques known in the art such as image stitching, image merging, image fusion, and similar; and enables the correction for optical parallax and other effects known in optics, and the generation of mirror image 190 simulating that that would be generated for the observer by a passive mirror surface of known extent and location.

Mirror image 190 may be displayed on optional display 140 and may represent a scene substantially similar to what observer 106 would see were display 140 replaced by an optical mirror. Mirror image 190 may also in parallel be stored in optional mass storage 870 for later viewing or processing, or for remote transmission. Inputs and outputs to and from active-tracking based system 800 are achieved through input and output functionality represented by interface 880. Input and output functionalities include user settings; links to an image data base; and a “live data” link for the reception of remotely acquired scene data.

Without departing from the scope hereof, motion/observer detection sub-system 810 may not detect motion of observer 106, but rather detect another indication of the presence, and optionally location, of observer 106.

Motion/observer detection sub-system 810 and at least a portion of computer 830 form an embodiment of position sensing module 110. Camera(s) 850, controller 840, and, optionally, image generator 860 form an embodiment of camera module 130.

Without departing from the scope hereof, mirror image 190 may be only one component of the scene that is presented on display 140. For illustration, other information, including other image input streams, may be combined and/or merged with mirror image 190 to generate the image displayed by addressable active display.

In one embodiment, a remote user of active-tracking based system 800 specifies a direction in space as corresponding to the position of an observer 106, whether or not a physical observer 106 is present in the system proximity. In one example, this remote user utilizes remote control system 180. The remote user may specify a raster sequence of three-dimensional vector corresponding to a “virtual” observer, as discussed in reference to FIGS. 1 and 2.

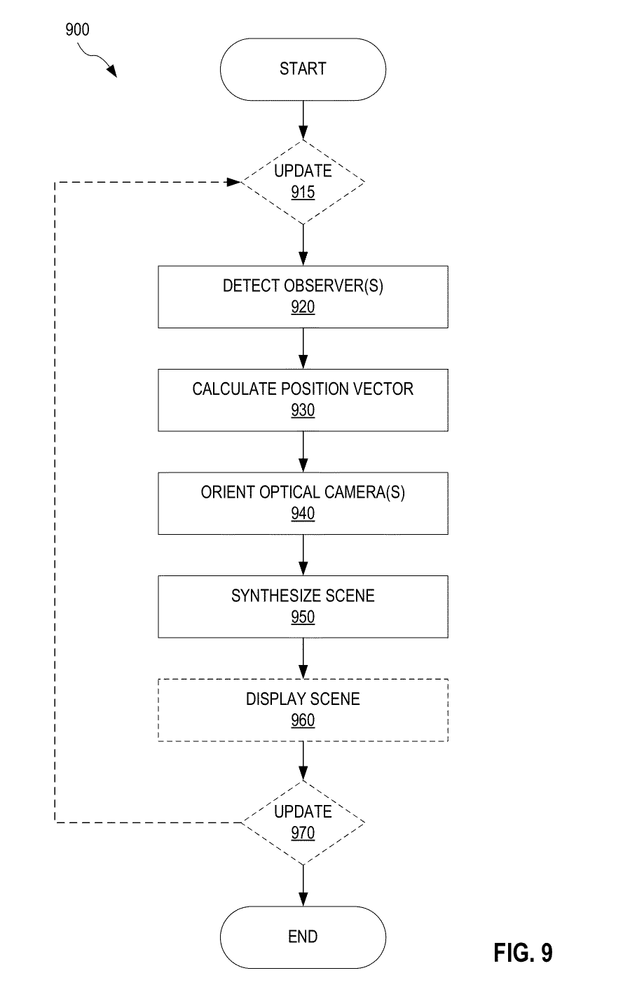

FIG. 9 illustrates one exemplary active-tracking based method 900 for generating, and optionally displaying, mirror image 190 (FIG. 1) using at least one rotatable camera device. Active-tracking based method 900 is an embodiment of active-tracking based method 200 (FIG. 2). Active-tracking based method 900 is performed by, for example, active-tracking based system 100, 400 (FIG. 4), 500 (FIG. 5), 600 (FIG. 6), 700 (FIG. 7), or 800 (FIG. 8).

In a step 920, method 900 detects the presence of observer 106. In one example of step 920, at least one position sensor 112 detects the presence of observer 106. In another example of step 920, motion/observer detection sub-system 810 detects the presence of observer 106.

In a step 930, method 900 calculates position vector 108. In one example of step 930, position sensing module 110 calculates position vector 108 based upon measurements by position sensor(s) 112. In another example of step 930, computer 830 calculates position vector 108 based upon data received from motion/observer detection sub-system 810.

In a step 940, method 900 orients, based upon position vector 108, at least one camera device 132 along a respective direction to capture a respective image, such that the scene observed and/or synthesized by/from such image(s) substantially corresponds to the scene that observer 106 would observe were display 140 replaced by a reflective or semi-reflective surface of known shape, known orientation and known position with respect to display 140. As described above, step 940 may utilize camera module 130 implemented with one or a plurality of camera devices 132, wherein at least some of the plurality of optical cameras may have different optical axes orientations. In one example of step 940, display device 402 rotates camera module 412 or one or more camera devices 512 along viewing direction 126. In another example of step 940, controller 840 rotates camera(s) 850 along viewing direction 126.

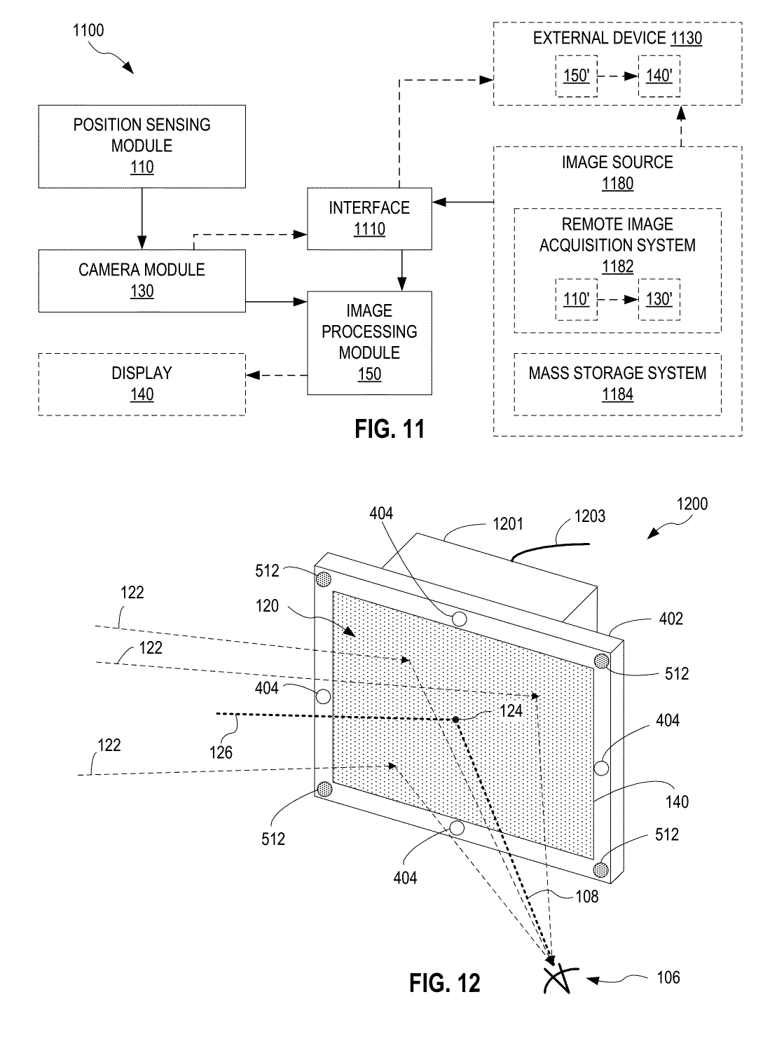

In a step 950, method 900 synthesizes mirror image 190 from one or more images captured by the camera device(s) oriented in step 940. In one embodiment, mirror image 190 is at least a portion of an image captured by one camera device in step 940. In another embodiment, step 950 synthesizes mirror image 190 from a plurality of images captured by a respective plurality of camera devices in step 940. Step 950 may further merge mirror image 190 with a second image 152, different from image(s) captured in step 940, to produce a merged image that includes at least a portion of mirror image 190 and a portion of image 152. Examples of such image merging are discussed below in reference to FIGS. 11-17. Without departing from the scope hereof, image 152 may be a void image, such that the merged image is mirror image 190. In one example of step 950, camera module 130 outputs, as mirror image 190, at least a portion of an image captured by a rotatable embodiment of camera device 132. In another example of step 950, image generator 134 synthesizes mirror image 190 from a plurality of images captured by a plurality of rotatable embodiments of camera device 132. Optionally, image processing module 150 merges mirror image 190 with a second image 152 to produce a merged image that includes a portion of mirror image 190 and a portion of image 152. In yet another example of step 950, computer 830 synthesizes mirror image 190 from (a) one image captured in step 940, (b) a plurality of images captured in step 940, or (c) one or more images captured in step 940 and a second image 152 retrieved from mass storage 870 or received from interface 880.

In an optional step 960, method 900 displays, on display 140, mirror image 190 or a merged image including at least a portion of mirror image 190 and a portion of image 152.

In one embodiment, method 900 includes a step 970 that directs method 900 to an update step 915, thus repeating steps 920, 930, 940, 950, and optionally 960. In this embodiment, method 900 generates a stream of mirror images 190 or a stream of images each including at least a portion of a corresponding mirror image 190. Thereby, method 900 may dynamically update display 140 in accordance with a possibly varying location of observer 106.

At least a portion of method 900 may be implemented as machine-readable instructions encoded on non-transitory media within active-tracking based system 100.

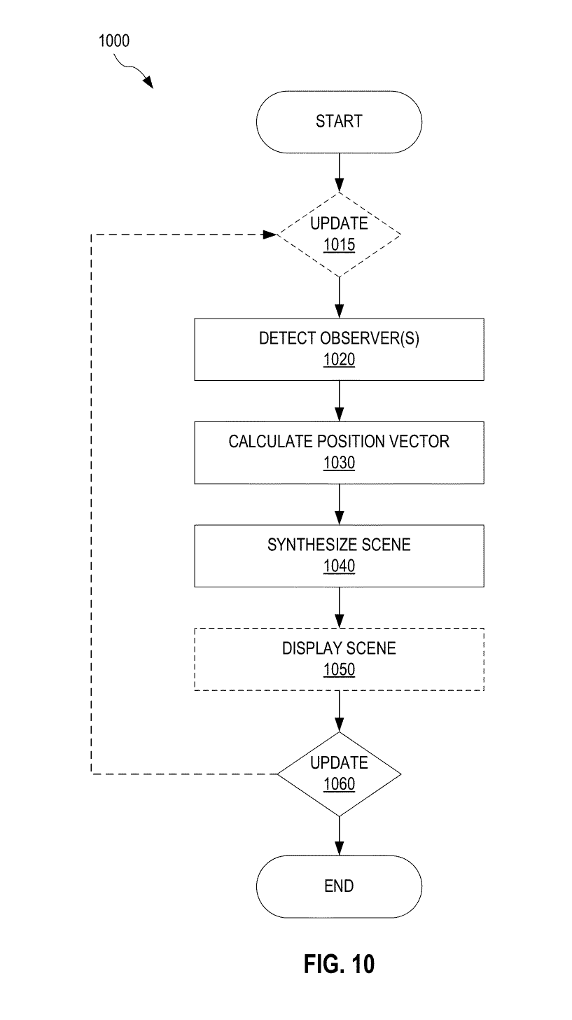

FIG. 10 illustrates one exemplary active-tracking based method 1000 for generating, and optionally displaying, mirror image 190 (FIG. 1) using a plurality of camera devices 132. Each camera device 132 may be implemented as a stationary or rotatable camera device. Active-tracking based method 900 is an embodiment of active-tracking based method 200 (FIG. 2). Active-tracking based method 900 is performed by, for example, active-tracking based system 100, 400 (FIG. 4), 500 (FIG. 5), 600 (FIG. 6), 700 (FIG. 7), or 800 (FIG. 8).

In a step 1020, method 1000 detects the presence of observer 106. Step 1020 is similar to step 920 (FIG. 9).

In a step 1030, method 1000 calculates position vector 108. Step 1030 is similar to step 930 (FIG. 9).

In a step 1040, method 1000 captures a plurality of images using a respective plurality of camera devices 132, and synthesizes mirror image 190 from this plurality of images. Step 1050 may further merge mirror image 190 with a second image 152 to produce a merged image that includes at least a portion of mirror image 190 and a portion of image 152 different from any of the plurality of images captured in step 1040. Without departing from the scope hereof, image 152 may be a void image, such that the merged image is mirror image 190. In one example of step 1040, image generator 134 synthesizes mirror image 190 from a plurality of images captures by a plurality of camera device 132. Optionally, image processing module 150 merges mirror image 190 with a second image 152 to produce a merged image that includes a portion of mirror image 190 and a portion of image 152. In another example of step 1040, computer 830 synthesizes mirror image 190 from (a) a plurality of images captured in step 1040, or (b) a plurality of images captured in step 1040 and a second image 152 retrieved from mass storage 870 or received from interface 880.

In an optional step 1050, method 1000 displays, on display 140, mirror image 190 or a merged image including at least a portion of mirror image 190 and a portion of a second image 152.

In one embodiment, method 1000 includes a step 1060 that directs method 1000 to an update step 1015, thus repeating steps 1020, 1030, 1040, and optionally 1050. In this embodiment, method 1000 generates a stream of mirror images 190 or a stream of images each including at least a portion of a corresponding mirror image 190. Thereby, method 1000 may dynamically update display 140 in accordance with a possibly varying location of observer 106.

At least a portion of method 1000 may be implemented as machine-readable instructions encoded on non-transitory media within active-tracking based system 100.

FIG. 11 illustrates one exemplary active-tracking based system 1100 for generating, and optionally displaying, a mirror image 190 (FIG. 1), and which includes merge and record functions. Active-tracking based system 1100 is similar to active-tracking based system 100.

As compared to active-tracking based system 100, active-tracking based system 1100 includes image processing module 150 and an interface 1110. Interface 1110 receives an external image stream from an image source 1180.

Active-tracking based system 1100 operates position sensing module 110 and camera module 130, as discussed in reference to FIG. 1, to produce mirror image 190. Image processing module 150 receives, via interface 1110, an external image from image source 1180. Image processing module 150 merges this external image with mirror image 190 to generate a merged image. Optionally, image processing module 150 displays this merged image on optional display 140.

Optionally, active-tracking based system 1100 includes image source 1180. In one embodiment, image source 1180 includes remote image acquisition system 1182. Remote image acquisition system 1182 may be similar to active-tracking based system 100 and thus include a position sensing module 110′ and a camera module 130′. Position sensing module 110′ and camera module 130′ are similar to position sensing module 110 and camera module 130. In an exemplary use scenario associated with this embodiment, the external image received from image source 1180 is at least a portion of a mirror image 190′ generated by remote image acquisition system 1182, wherein mirror image 190′ is similar to mirror image 190. In another embodiment, image source 1180 includes a mass storage system 1184 that holds one or more images to be used by image processing module 150.

In one embodiment, interface 1110 is configured to output images generated by camera module 130 and/or image processing module 150 to an external device 1130. Interface 1110 may output mirror image 190 generated by camera module 130 to external device 1130. External device 1130 may include an image processing module 150′ and a display 140′, which are similar to image processing module 150 and a display 140, respectively. Image processing module 150′ may receive mirror image 190, or a portion thereof, generated by camera module 130, and merge mirror image 190 with an image received from image source 1180. External device 1130 may display the resulting merged image on display 140′.

Without departing from the scope hereof, active-tracking based system 1100 may merge streams of images.

FIG. 12 illustrates one exemplary active-tracking based system 1200 for generating, and optionally displaying, a mirror image 190 (FIG. 1), and which includes merge and record functions. Active-tracking based system 1200 is an embodiment of active-tracking based system 1100 (FIG. 11).

Although shown in FIG. 12 as (a) implementing position sensing module 110 and camera module 130 as discussed in reference to FIG. 7, active-tracking based system 1200 may utilize other implementations of position sensing module 110 and camera module 130, without departing from the scope hereof. Active-tracking based system 1200 may implement position sensing module 110 and camera module 130 as discussed in reference to FIGS. 4-6.

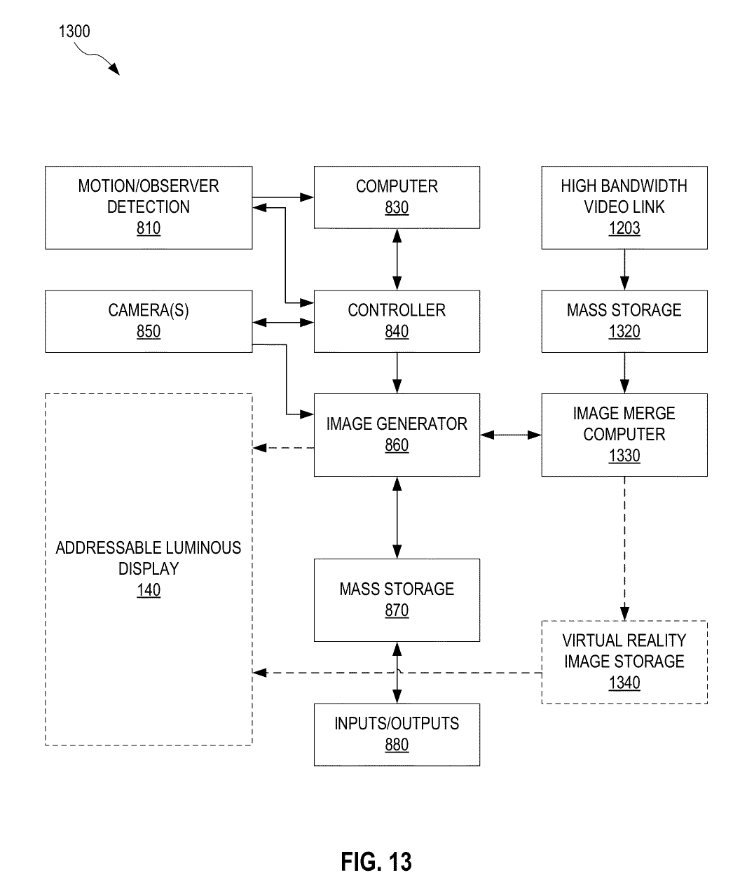

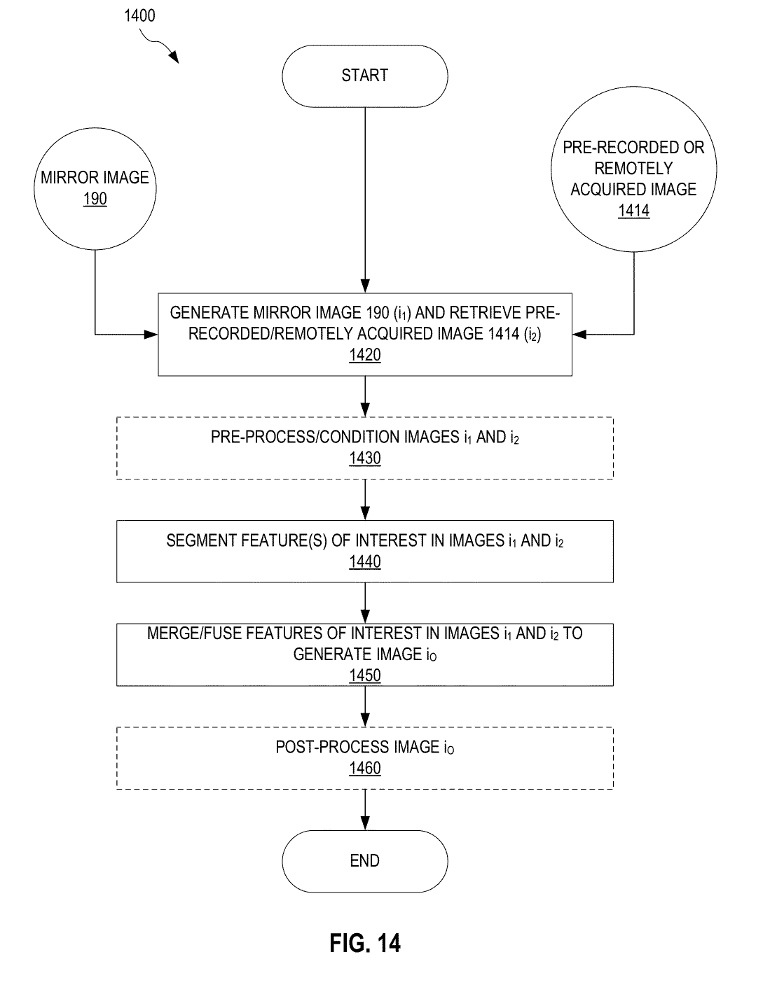

As compared to active-tracking based system 700, active-tracking based system 1200 further includes a high-bandwidth link 1203 to interface with remote image acquisition systems and also a mass storage system (not shown), such as image source 1180. A computer implemented in a sub-system 1201 performs the image merge and storage functions, as discussed in reference to FIG. 11 or as further described below in reference to FIGS. 13 and 14.

FIG. 13 illustrates one exemplary active-tracking based system 1300 for generating, and optionally displaying, mirror image 190 (FIG. 1), and which includes merge and record functions. Active-tracking based system 1300 is an embodiment of active-tracking based system 1100 (FIG. 11).

Active-tracking based system 1300 is similar to active-tracking based system 800 (FIG. 8). As compared to active-tracking based system 800, active-tracking based system 1300 includes (a) image generator 860 and (b) mass storage 870 that stores images generated by image generator 860. Interface 880 enables interaction with a user for various system settings and options. The merge and record components include (a) a high-bandwidth video link 1203 to communicate with external and/or remote image sequences sources (such as image source 1180), (b) a mass storage 1320 to store associated data, (c) an image merge computer 1330 which performs the merging of two input images, one generated by active-tracking based system 1300 from images captured by camera(s) 850, the other one previously stored on mass storage 1320 or remotely acquired and transmitted via video link 1203. Image merge computer 1330 provides as output a “virtual reality” image comprising features extracted and possibly subsequently modified via image processing from both input images. The resulting output virtual reality image may be stored on an optional virtual reality image storage 1340 and/or sent to optional display 140 for presentation to a user, such as observer 106. Although shown in FIG. 13 as being separate computers, a single computer may implement computer 830 and image merge computer 1330. Similarly, virtual reality image storage 1340 and mass storage 870 may be implemented as a single storage device. High-bandwidth video link 1203 includes, for example, a co-axial cable, a Wi-Fi antenna, an Ethernet cable, a fiber optic cable, or any other means of transferring data appropriate for the high-bandwidth generally required for the transmission of image information.

Without departing from the scope hereof, active-tracking based system 1300 may include only one of high-bandwidth video link 1203 and mass storage 1320.

FIG. 14 illustrates one exemplary method 1400 for merging two input images. Method 1400 is performed by active-tracking based system 1100 (FIG. 11), for example. Method 1400 is an embodiment of method 200 that includes step 244.

In a step 1420, method 1400 generates mirror image 190 (i₁) and retrieves a pre-recorded or remotely acquired image 1414 (i₂). In the following, method 1400 is discussed in the context of merging a single mirror image 190 with a single pre-recorded or remotely acquired image 1414. However, it is understood that method 1400 may be utilized to merge mirror image 190 with pre-recorded or remotely acquired image 1414, for respective streams of mirror image 190 and pre-recorded or remotely acquired image 1414.

In one example of step 1420, position sensing module 110 and camera module 130 of active-tracking based system 1100 (FIG. 11) cooperate to generate mirror image 190. Next, in this example, image processing module 150 (a) retrieves mirror image 190 from camera module 130 and (b) retrieves a pre-recorded or remotely acquired image 1414 from image source 1180 via interface 1110. In another example of step 1420, motion/observer detection sub-system 810, camera(s) 850, and optionally image generator 860 cooperate to generate mirror image 190. Next, in this example of step 1420, image merge computer 1330 (FIG. 13) (a) retrieves mirror image 190 from image generator 860 (or directly from camera(s) 850), and (b) retrieves a pre-recorded or remotely acquired image 1414 from mass storage 1320 or high-bandwidth video link 1203 (FIG. 12).

In one scenario, pre-recorded or remotely acquired image 1414 is generated by another active-tracking based system for generating, and optionally displaying, a mirror image. For example, a remotely acquired image 1414 is produced from one or more images captured simultaneously with the one or more images used to generate mirror image 190.

When processing image sequences, step 1420 may utilize user inputs and/or automated image sequence analysis to determine which images of the image sequences to process.

In an optional step 1430, method 1400 preprocesses mirror image 190 and pre-recorded or remotely acquired image 1414. Step 1430 includes applications of algorithms that will help the subsequent step of image segmentation for the extraction of features of interest. Accordingly, the applied algorithms may be task dependent. Often a high-pass filter is applied to an image when one is interested in finding object/feature edges. In other situations, cross-correlations with a specific set of image pattern templates are calculated. Use of a-priori information is known to lead to better image segmentation performance. The field of computer vision has grown enormously in the last twenty years, and many techniques and algorithms are available for pre-processing and segmenting images, as known in the art. Examples of text books pertaining to the field include “Computer Vision” by D H Ballard and C M Brown (Prentice Hall, 1982) and “Computer Vision: Algorithms and Applications” by R Szeliski (Springer, 2011). In one example of step 1430, image processing module 150 of active-tracking based system 1100 pre-processes mirror image 190 and pre-recorded or remotely acquired image 1414. In another example, image merge computer 1330 processes mirror image 190 and pre-recorded or remotely acquired image 1414.

In a step 1440, method 1400 segments features from mirror image 190 and pre-recorded or remotely acquired image 1414. In one scenario, step 1440 segments out and retains from pre-recorded or remotely acquired image 1414 a feature of interest, such as the body and face of a remote interlocutor (e.g., an observer 106 of a remote active-tracking based system for generating, and optionally displaying, a mirror image). In this scenario, mirror image 190 then serves as the background upon which such feature of interest is superimposed. Step 1440 is performed, for example, by image processing module 150 of active-tracking based system 1100 or by image merge computer 1330.

In a step 1450, the features of interest segmented out in step 1440 are merged together, to create a synthetic output image i_{O}. For example, referring to the exemplary discussed in reference to step 1440, the person in remote communication via video link would appear with, as a background, mirror image 190. Step 1540 may include processing steps to ensure that the generated image looks natural to the local observer. For example, a region of the image outside the segmented features from the remote video images may be defined, and the pixel values in that region may be calculated so that a smooth transition occurs across the two sub-image boundaries. As indicated above more generally with respect to the field of computer vision, there exist a number of approaches that may be applied to ensure such a result. Step 1450 may utilize such approaches. Step 1450 is performed, for example, by image processing module 150 of active-tracking based system 1100 or by image merge computer 1330.

In an optional step 1460, method 1400 applies post-processing to the merged image i_{O}, to ensure that the merged image i_{O} possesses specific/desirable properties for display to the local observer 106. Step 1460 is performed, for example, by image processing module 150 of active-tracking based system 1100 or by image merge computer 1330.

Although not shown in FIG. 14, merged image i_{O} may be stored to memory of the active-tracking based system or displayed on display 140 of the active-tracking based system, without departing from the scope hereof. In one exemplary use scenario, the active-tracking based system operates on sequences of images that are presented in a video mode. Method 1400 may account for the temporal relationship between subsequent images, for example as is known in the art. In one example, the result of one image segmentation may be used as an input in the processing for segmenting the next image in a sequence.

Without departing from the scope hereof, method 1400 may be utilized in other applications, for example applications wherein an image stream is transferred over a reduced-bandwidth connection. For example, segmentation of a remotely acquired image 1414 in step 1440 may be performed by the remote system, thereby decreasing bandwidth requirements to high-bandwidth link 1203.

In one scenario, active-tracking based system 1100 (FIG. 11) implements method 1400 to generate a virtual reality sequence of images. In this scenario, method 1400 may utilize a sequence of pre-recorded images 1414. In another scenario, two active-tracking based systems 1100 (FIG. 11), communicatively coupled with each other, implement method 1400 to facilitate a live video conference between to corresponding observers 106. In this scenario, active-tracking based system 1100 utilizes method 1400 to enable communication between the two observers 106 with a much enhanced sense of presence: a live image of the remote participant being presented to the local participant as being part of his/her local environment.

At least a portion of method 1400 may be implemented as machine-readable instructions encoded on non-transitory media within active-tracking based system 100.

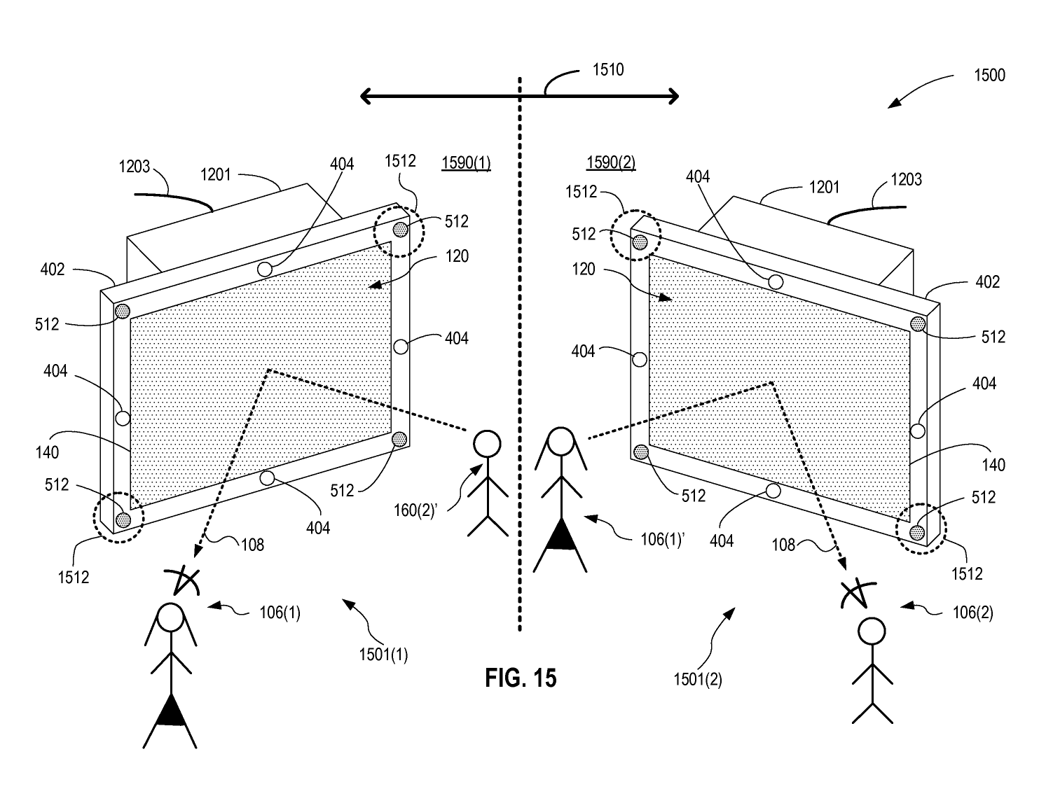

FIG. 15 illustrates one exemplary live-video conference system 1500 that includes two communicatively coupled active-tracking based systems 1501 (FIG. 11) for displaying a mirror image and with merge and record functions. Each active-tracking based system 1501 is an embodiment of active-tracking based system 1100 (FIG. 11) and utilizes a stream of remotely acquired images 1414, generated by the other active-tracking based system 1501, to perform method 1400 (FIG. 14) by. Although shown in FIG. 15 as being implemented as active-tracking based system 1200 (FIG. 12), each active-tracking based system 1501 may be implemented as another embodiment of active-tracking based system 1100, without departing from the scope hereof.

Active-tracking based system 1501(1) is located in an environment 1590(1) and is viewed by an observer 106(1). Active-tracking based system 1501(2) is located in an environment 1590(2) and is viewed by an observer 106(2). Active-tracking based systems 1501(1) and 1501(2) are communicatively coupled via a high-bandwidth video link 1510 compatible with interfacing with high-bandwidth video link 1203 of each of active-tracking based systems 1501(1) and 1501(2).

Active-tracking based system 1501(1) includes at least one camera device 512 that captures images to generate a stream of mirror images 190 for environment 1590(1), based upon position vector 108 associated with observer 106(1), as discussed for example in reference to FIG. 2. Active-tracking based system 1501(1) also includes at least one camera device 512 (for example the two camera devices 512 labeled 1512) that captures a stream of images of observer 106(1), or a stream of images from which a stream of images of observer 106(1) may be generated. Active-tracking based system 1501(1) may utilize position sensing module 110, implemented with position sensors 404, to determine the position of observer 106(1) and actively track observer 106(1), to produce a stream of images of observer 106(1). In one example, the images of observer 106(1) are generated in a manner similar to the generation of mirror images 190 in steps 220 and 230 of method 200, except that the images of observer 106(1) represent a view along position vector 108 instead of viewing direction 126. The stream of images of observer 106(1) is communicated, via high-bandwidth link 1510, to active-tracking based system 1501(2). Active-tracking based system 1501(2) implements the image stream of observer 106(1) in method 1400 as a stream of remotely acquired images 1414.

Likewise, active-tracking based system 1501(2) includes at least one camera device 512 that captures images to generate a stream of mirror images 190 for environment 1590(2), based upon position vector 108 associated with observer 106(2), as discussed for example in reference to FIG. 2. Active-tracking based system 1501(2) also includes at least one camera device 512 512 (for example the two camera devices 512 labeled 1512) that captures a stream of images of observer 106(2), or a stream of images from which a stream of images of observer 106(2) may be generated, as discussed above in reference to active-tracking based system 1501(1). This stream of images of observer 106(2) is communicated, via high-bandwidth link 1510, to active-tracking based system 1501(1). Active-tracking based system 1501(1) implements the image stream of observer 106(2) in method 1400 as a stream of remotely acquired images 1414.

In one embodiment, each active-tracking based system 1501 utilizes one camera device 512 (or one set of camera devices 512) to capture images used to generate mirror image 190, and another camera device 512 (or another set of camera devices 512) to capture images of the local observer 106. In another embodiment, each active-tracking based system 1501 captures images used generate mirror image 190 and images of the local observer 106 using the same camera device 512 or the same set of camera devices 512.

Active-tracking based system 1501(1) performs method 1400, utilizing the image stream of observer 106(2), to provide a “virtual reality” image stream wherein remote observer 106(2) is seen as if immersed within the local environment 1590(1), as indicated by observer 106(2)′. Similarly, active-tracking based system 1501(2) performs method 1400, utilizing the image stream of observer 106(1), to provide a “virtual reality” image stream wherein remote observer 106(1) is seen as if immersed within the local environment 1590(2), as indicated by observer 106(1)′.

Accordingly, telecommunication participants 106(1) and 106(2) are connected live through the linked active-tracking based systems 1501(1) and 1501(2), and live-video conference system 1500 provides a “virtual reality” image wherein the remote participants are seen as if they were immersed within the local environment of their interlocutors.

Without departing from the scope hereof, each or one of environments 1590(1) and 1590(2) may be associated with a plurality of observers 106. In this scenario, cameras(s) 512 may generate (a) separate image streams of each of the plurality of observers or (b) a single image stream including the plurality of observers, wherein each image of the single image stream is segmented to extract an image of each of the plurality of observers.

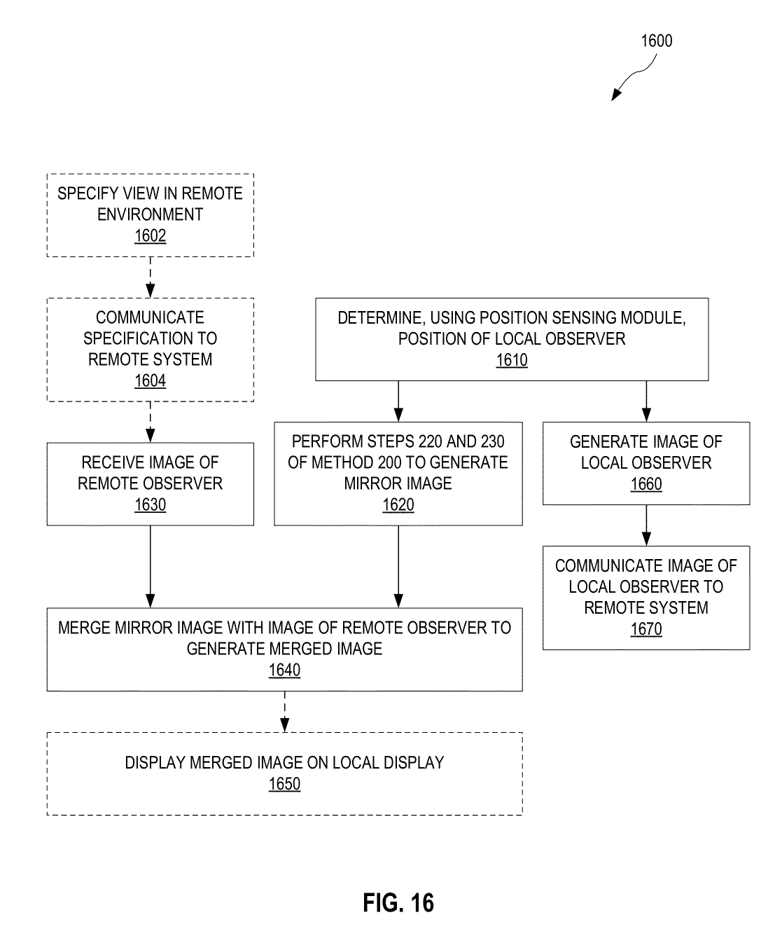

FIG. 16 illustrates one exemplary active-tracking based method 1600 for generating live video conference imagery. Method 1600 is performed by live video conference system 1500 (FIG. 15). FIG. 16 shows the steps performed by a single active-tracking based system 1501. It is understood that each active-tracking based system 1501 of live video conference system 1500 performs the steps shown in FIG. 16. Live video conference system 1500 may perform method 1600 repeatedly to generate a live video conference image stream.

In a step 1610, position sensing module 110 (FIG. 1) of the local active-tracking based system 1501 determines the position of the local observer 106, as discussed in reference to step 210 of method 200 (FIG. 2). In a step 1620, method 1600 performs steps 220 and 230 to generate mirror image 190 for the local observer 106, as discussed in reference to FIG. 2. In a step 1630, the local active-tracking based system 1501 receives an image of the remote observer 106, as discussed in reference to FIG. 15. In a step 1640, the local active-tracking based system merges mirror image 190 with the image of the remote observer 106 to produce a merged image, as discussed in reference to FIG. 15. Optionally, this merged image is displayed on a display of the local active-tracking based system 1501 in a step 1650, as discussed in reference to FIG. 15. In a step 1660, the local active-tracking based system 1501 generates an image of the local observer 106, as discussed in reference to FIG. 15. In a step 1670, the local active-tracking based system 1501 communicates this image of the local observer 106 to the remote active-tracking based system 1501, as discussed in reference to FIG. 15.

In certain embodiments, active-tracking based method 1600 allows local observer 106 to specify a view associated with the image received in step 1630. In such embodiments, method 1600 includes steps 1602 and 1604. In step 1602, local observer 106 (or another operator or operating system associated with local active-tracking based system 1501) specifies a view in remote environment 1590. In step 1604, local active-tracking based system 1501 communicates this view specification to remote active-tracking based system 1501, such that remote active-tracking based system 1501 generates the image of step 1630 according to the specification of step 1602. The view specified in step 1602 need not coincide with a physical, remote observer 106. In one example of step 1602, the view corresponds to a view of interest in remote environment 1590. In another example, active-tracking based method 1600 performs step 1602 repeatedly to perform a raster scan in remote environment 1590. This raster scan may serve to search, and optionally locate, an object of interest such as a human observer 106. Optionally, after locating this object of interest, remote active-tracking based system 1501 may continue to actively track this object of interest, using position sensing module 110, to generate a stream of images of this object of interest to be used in step 1630.

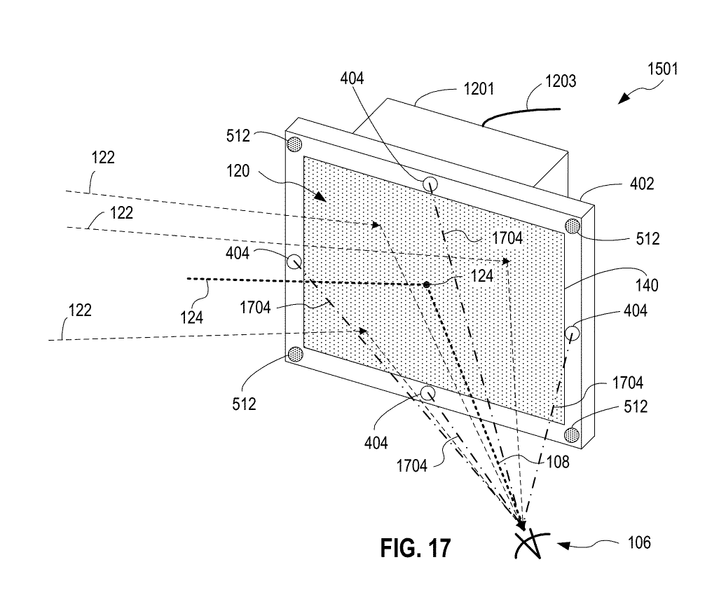

FIG. 17 illustrates generation of a three-dimensional model of an observer 106 (FIG. 1) by active-tracking based system 1501 of live video conference system 1500 (FIG. 15). This three-dimensional model may be utilized in step 1660 of method 1600 (FIG. 16) to further enhance the rendition of a local observer 106.

In the following description it is assumed that position sensors 404, or at least a subset of a multiplicity of position sensors 404 comprise a video camera. A three-dimensional model of the local observer 106 may be generated, as known in the art, in at least two ways. In one embodiment, because the same observer 106 is seen over time by at least one position sensor 404 of active-tracking based system 1501, such as position sensing module 504 of FIG. 5 (which is, for the purpose of FIG. 17, understood to also include an optical camera), the observer will be seen over time (due to his own motion during that time) at a variety of angles and orientations with respect to such camera, thus allowing the definition and progressive refinement of a three-dimensional model of the local observer 106. In another embodiment, active-tracking based system 1501 includes a plurality of camera devices 512 arranged at a plurality of locations on active-tracking based system 1501. A subset of the image streams supplied by those camera devices 512 will contain the observer. These camera devices 512 de-facto provide views of the local observer 106 at a variety of angles and orientations. In this embodiment, this plurality of views is used to generate a three-dimensional model of the local observer 106, as known in the art.

Active-tracking based system 1501 may leverage both of these two methods, in combination, to define a further improved three-dimensional model as compared to a model that could be obtained from only one of them. In one such example, position sensors 404 also include an optical sensor/camera. Position sensors 404 then provide optical input video streams of the local observer 106 at a variety of angles 1704. Active-tracking based system 1501 may then analyze and process these input video streams to generate a three-dimensional model of the local observer 106. This three-dimensional model, in turn, may be remotely transmitted for further display enhancement to a remote user of remote active-tracking based system 1501 or other display system capable of leveraging the additional information provided by the three-dimensional model thus generated.

It is understood that in the above description, any sensor or optical device comprising a video camera, such as camera device 132 or certain embodiments of position sensor 112, may contribute image information about observer 106 that may be leveraged for the generation of a three-dimensional model of observer 106.

The three-dimensional model in turn may be transmitted to a remote video-conference participant, and utilized to enhance the virtual-reality representation of the observer to the remote participant. Display systems capable of representing three-dimensional information are known in the art, such as (but not limited to) systems where the observer wears google with light wave-length specific response. Many different technologies are applicable to the goal of enhancing the three-dimensional perception of a scene, as known in the art, and apply to active-tracking based system 1501 as well as other embodiments of active-tracking based system 100.

Corresponding reference numerals indicate corresponding parts throughout the several views of the drawings.

An embodiment of the present invention may be obtained in the form of computer-implemented processes and apparatuses for practicing those processes. The present invention may also be embodied in the form of a computer program product having computer program code containing instructions embodied in tangible media, such as floppy diskettes, CD-ROM, hard drives, digital video disks, USB (universal serial bus) drives, or any other computer readable storage medium, such as random access memory (RAM), read only memory (ROM), or erasable programmable read only memory (EPROM), for example, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic waves and radiation, wherein when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to generate a two-dimensional image representative of what an observer would see were the display surface to be replaced by an optical mirror of known shape and orientation.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of terms first, second, etc. do not denote any order of importance, but rather the terms first, second, etc. are used to distinguish one element from another. Furthermore, the use of terms a, an, etc. do not denote a limitation of quantity, but rather denote the presence of at least one of the referenced item.

The advantages of the above described embodiment and improvements should be readily apparent to one skilled in the art. Accordingly, it is not intended that the invention be limited by the particular embodiment or form described above, but by the appended claims.

Changes may be made in the above systems and methods without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and systems, which, as a matter of language, might be said to fall therebetween.

What is claimed is:

1. An active-tracking based system for generating a mirror image, comprising:
a position sensing module for determining position of an observer relative to a surface; and
a camera module for generating the mirror image based upon the position, as the mirror image would have been experienced by the observer if the surface had been a mirror.

2. The active-tracking based system of claim 1, further comprising a display for displaying the mirror image.

3. The active-tracking based system of claim 2, the display coinciding with the surface.

4. The active-tracking based system of claim 1, the surface being a virtual surface of known shape, orientation, and location.

5. The active-tracking based system of claim 1, the camera module including at least one rotatable camera device for being oriented, according to the position of the observer, to capture an image along viewing direction associated with the mirror image.

6. The active-tracking based system of claim 1,
the camera module including a plurality of camera devices located at a respective plurality of different locations; and
the active-tracking based system further comprising an image generator for processing a plurality of images captured by the plurality of camera devices, respectively, to generate the mirror image.

7. The active-tracking based system of claim 6, each of the plurality of camera devices having fixed orientation.

8. The active-tracking based system of claim 6, at least one of the plurality of camera devices being rotatable.

9. The active-tracking based system of claim 1, the position sensing module including a rotatable position sensor for being oriented, according to the position of the observer, to actively track the position of the observer.

10. The active-tracking based system of claim 1, the position sensing module including a plurality of position sensors for cooperatively determining the position of the observer.

11. The active-tracking based system of claim 1, further comprising an image processing module for merging at least a portion of the mirror image with a second image to produce a merged image.

12. The active-tracking based system of claim 11, further comprising a link for receiving the second image.

13. The active-tracking based system of claim 11, further comprising a display for displaying the merged image.

14. The active-tracking based system of claim 1, the camera module including a plurality of camera devices for generating a three-dimensional image, and the mirror image being a three-dimensional mirror image.

15. The active-tracking based system of claim 1, the camera module being adapted to determine, from the position, a viewing direction associated with the mirror image.

16. The active-tracking based system of claim 1, the camera module including at least one camera device for generating an image of the observer.

17. The active-tracking based system of claim 1, further comprising a control system for controlling viewing direction associated with image generated by at least one camera device of the camera module.

18. An active-tracking based method for generating a mirror image, comprising:
determining position of an observer relative to a surface;
capturing at least one image; and
generating, from the at least one image, the mirror image as the mirror image would have been experienced by the observer if the surface had been a mirror.

19. The active-tracking based method of claim 18, the step of determining comprising determining the position using at least one position sensor.

20. The active-tracking based method of claim 18, further comprising displaying the mirror image on a display.

21. The active-tracking based method of claim 20, the step of displaying comprising displaying the mirror image on a display coinciding with the surface.

22. The active-tracking based method of claim 18, the step of capturing comprising:
orienting, according to the position of the observer, at least one camera along viewing direction associated with the mirror image; and
capturing the at least one image along the viewing direction.

23. The active-tracking based method of claim 22, further comprising:
determining the viewing direction based upon the position of the observer.

24. The active-tracking based method of claim 18,
the step of capturing comprising capturing a plurality of images, using a respective plurality of camera devices located at a respective plurality of different locations; and
the step of generating comprising synthesizing the mirror image from the plurality of images.

25. The active-tracking based method of claim 24,
further comprising determining, based upon the position of the observer, a viewing direction associated with the mirror image; and
the step of generating comprising synthesizing the mirror image as an image along the viewing direction.

26. The active-tracking based method of claim 18, further comprising:
merging the mirror image with a second image to produce a merged image.

27. The active-tracking based method of claim 26, in the step of merging, the second image being a prerecorded image.

28. The active-tracking based method of claim 26, in the step of merging, the second image being based upon image capture that is substantially simultaneously with capture of the at least one image in the step of capturing.

29. The active-tracking based method of claim 28, in the step of merging, the second image including a remote observer and the merged image showing the remote observer in environment of the observer.

30. The active-tracking based method of claim 29, further comprising controlling view in remote environment associated with the remote observer.

31. The active-tracking based method of claim 18, further comprising:
capturing an observer image of the observer; and
communicating the observer image to a remote display system.

32. The active-tracking based method of claim 31, further comprising:
the step of capturing at least one image including capturing a time series of images to generate a three-dimensional model of the observer; and
the step of merging including utilizing the three-dimensional model to show the remote observer in the merged image.

33. The active-tracking based method of claim 18, comprising repeating the steps of determining, capturing, and generating to actively track the observer and generate a corresponding stream of mirror images.
